(19) United States
(12) Patent Application Publication
(10) Pub. No.: US 2015/0339054 A1
(43) Pub. Date: Nov. 26, 2015

(54) METHOD AND SYSTEM FOR INPUTTING AND UPLOADING DATA

(71) Applicant: MXTRAN INC., Hsin Chu (TW)

(72) Inventors: Yvette E-Wen Lin, Hsinchu (TW); Hsiu-Kang Chen, Hsinchu (TW); Lung-Chiu Chang-Hsu, Hsinchu (TW); Jen-Ho Chang, Hsinchu (TW)

(21) Appl. No.: 14/483,191

(22) Filed: Sep. 11, 2014

(30) Foreign Application Priority Data
May 23, 2014 (TW) 103118035

(51) Int. Cl. G06F 3/0488; G06F 21/60

(52) U.S. Cl. CPC G06F 3/04886; G06F 21/606

(57) ABSTRACT

A method and a system for inputting and uploading data are disclosed. The data inputting and uploading method comprises following steps. A figure factor is generated by a user equipment according to a key rule. A dynamic keyboard is generated by the user equipment according to the figure factor, wherein the dynamic keyboard is composed of a plurality of figures. A permutation of the selected figures is recorded by the user equipment. The permutation of the selected figures is transformed into a hash code by the user equipment. The hash code is received and transformed into a plain code by a back-end device.

This application claims the benefit of Taiwan application Serial No. 103118035, filed May 23, 2014, the subject matter of which is incorporated herein by reference.

### BACKGROUND OF THE INVENTION

1. Field of the Invention

The invention relates in general to a method and a system for inputting and uploading data, and more particularly to a method and a system for inputting and uploading data by a dynamic keyboard.

2. Description of the Related Art

With the availability of Internet, many task such as shopping, bill payment, and fund transfer can be easily done via the network. Meanwhile, the user's private or sensitive data such as ID number, date of birth and credit card number need to be uploaded to the network.

However, the user equipment once connected to the Internet is exposed to the risk of being infected with Trojans and controlled by the crackers. The user's private or sensitive data may be stolen, and the user's assets may be jeopardized. For example, the Trojans may key log the data inputted to the user equipment by the user and obtain the user's account password. Or, the Trojans may change or capture the data inputted or received by the user. For example, during the process of fund transfer, the Trojans can change the transferee account to other account, and then restore the changed content to the original content when the back-end device transmits the confirmation information to the user equipment. Thus, it is very hard for the user to detect that the inputted data has been changed during the inputting process or the transmission process.

Therefore, it is necessary to provide a data inputting and uploading method with high security to protect the sensitive or private data inputted by the user.

### SUMMARY OF THE INVENTION

The invention is directed to a method and a system for inputting and uploading data. The method and the system have high security during the process of inputting data and the process of transmitting data.

According to one embodiment of the present invention, a data inputting and uploading method is disclosed. The method comprises following steps. A figure factor is generated by a user equipment according to a key rule. A dynamic keyboard is generated by the user equipment according to the figure factor, wherein the dynamic keyboard is composed of a plurality of figures. A permutation of the selected figures is recorded by the user equipment. The permutation of the selected figures is transformed into a hash code by the user equipment. The hash code is received and transformed into a plain code by a back-end device.

According to another embodiment of the present invention, a data inputting and uploading system is disclosed. The system comprises a user equipment and a back-end device. The user equipment comprises a safety component, a calculation unit, a graphic unit, a display unit, a storage unit and a user-end transmission unit. The safety component stores a key rule. The calculation unit generates a figure factor according to the key rule. The graphic unit generates a dynamic keyboard according to the figure factor, wherein the dynamic keyboard is composed of a plurality of figures. The display unit displays the dynamic keyboard. The storage unit records a permutation of the sequentially selected figures. The calculation unit transforms the of the sequentially selected figures into a hash code. The user-end transmission unit transmits the hash code to the back-end device. The back-end device comprises a back-end transmission unit and a code transforming unit, wherein the back-end transmission unit receives the hash code, and the code transforming unit transforms the hash code into a plain code.

Based on the key rule in a safety component, a dynamic keyboard through which the user can click and input private or sensitive plain code is generated on a user equipment. The dynamic keyboard is generated according to the figure factor, and the figure factor is generated by the physical safety component (high security). Furthermore, the user equipment only records a permutation of the selected figures when the user inputs a plain code, hence avoiding software tampering, key logging or unauthorized interception of private/sensitive plain code such as transferee account, transfer amount, account password.

Moreover, the permutation of the selected figures, which is generated when the user clicks the dynamic keyboard, is transformed into a hash code which is then transmitted to a back-end device. The back-end device obtains the hash code, and then transforms the hash code into a plain code according to a stored key rule. That is, the sensitive/private plain code is transformed into an encrypted hash code during the transmission process. Even if the encrypted hash code is intercepted during the transmission process, the cracker still cannot decrypt the encrypted hash code to obtain the plain code inputted by the user.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a flowchart of a data inputting and uploading method according to an embodiment of the invention.

FIG. 2 is a schematic diagram of a user equipment and a dynamic keyboard according to an embodiment of the invention.

FIG. 3 is a block diagram of a data inputting and uploading system according to an embodiment of the invention.

### DETAILED DESCRIPTION OF THE INVENTION

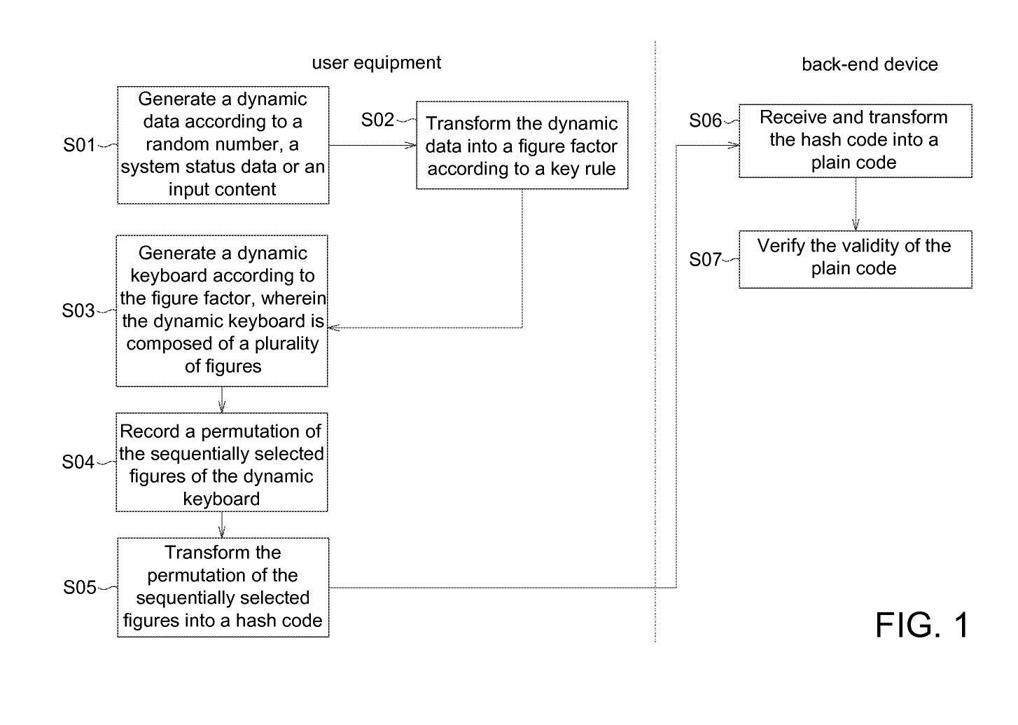

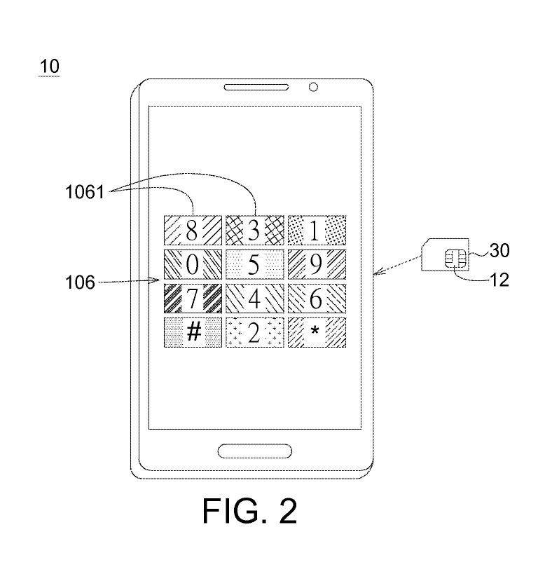

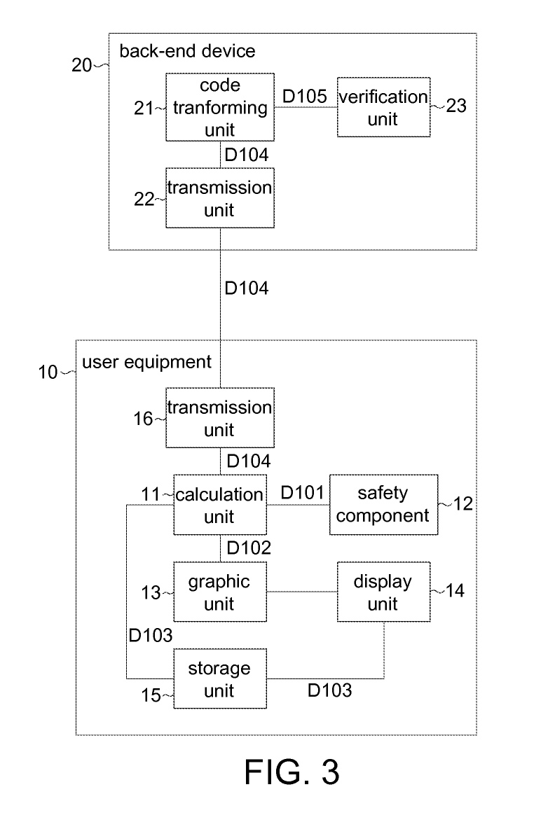

A method and a system for inputting and uploading data according to an embodiment of the invention are elaborated below with accompanying drawings FIGS. 1-3. FIG. 1 is a flowchart of a data inputting and uploading method according to an embodiment of the invention. FIG. 2 is a schematic diagram of a user equipment and a dynamic keyboard according to an embodiment of the invention. FIG. 3 is a block diagram of a data inputting and uploading system according to an embodiment of the invention.

Firstly, the method begins at step S01, a dynamic data is generated by a calculation unit 11 of a user equipment 10, wherein the dynamic data can be uploaded to a back-end device 20. The content of the dynamic data is not fixed, can be generated according to a random number, a system status data or an input content. The system status data comprises but is not limited to a system time or an identification code of the user equipment. Examples of the input content include a user account, a transferee account, an order number or a membership number commonly inputted by the user. The dynamic data may comprise one or a combination of the data exemplified above. Besides, the dynamic data can be generated at different time points. For example, the dynamic data can be generated when the user equipment 10 is activated or when the user prepares to input the data. The environmental status at the generation time of the dynamic data may vary, and the dynamic data may be different according to the environmental status. Thus, the dynamic date can be referred as one-time password (OTP), which provides higher security. In the present embodiment, the dynamic data can be used in subsequent steps of the data inputting and uploading method to generate a dynamic keyboard 106. It should be noted that in some embodiments, the dynamic data is not indispensable to the generation of the dynamic keyboard 106. That is, step S01 can be omitted.

Next, the method proceeds to step S02, a figure factor D102 of the dynamic keyboard 106 is generated by the calculation unit 11 of the user equipment 10 according to a key rule D101 of a safety component 12 and the dynamic data. The key rule D101 can be a one-time password, a symmetric key, an asymmetric key or a hash function, but not limit thereto. In an embodiment, the key rule D101 can be a function f(x) of dynamic data x, and different dynamic data x correspond to different function values, wherein the figure factor D102 is a function value. If step S01 is omitted, this implies that the figure factor D102 is generated from the key rule D101 directly without using any dynamic data. For example, when x=0, the figure factor D102 is expressed as f(0).

Then, the method proceeds to step S03, a dynamic keyboard 106 of FIG. 2 is drawn and displayed on the display unit 14 by a graphic unit 13 of the user equipment 10 according to the figure factor D102. The dynamic keyboard 106 is composed of a plurality of figures 1061 exemplified by 12 figures 1601 representing 10 numeric values 0-9 and 2 symbols * and #. Each figure 1061 displays an actual numeric value that the user intends to input, but the character of the numeric value, such as shape, size, foreground color (text color), text style (such as content, font, thickness, skew, extension, size and so on), background pattern, noise distribution, and sequence are determined according to the figure factor D102 generated via the safety component 12, and the variety of the character is not restricted in the invention. Only identical figure factors D102 can generate identical dynamic keyboards 106. In FIG. 2, the dynamic keyboard 106 is exemplified by a numeric keypad. In some embodiments, if the data that the user intends to input comprise letters or other symbols that cannot be found in the numeric keypad, the user equipment 10 can generate a corresponding dynamic keyboard 106.

Then, the method proceeds to step S04, when the user intends to input a plain code D105 and clicks the figure 1061 of the dynamic keyboard 106, the user equipment 10 records a permutation D103 of the selected figures. The plain code D105, for example, is a sensitive or private data such as a transferee account, a transfer amount, a membership account, a membership password and so on. The user equipment 10 does not record the content of the plain code D105. Instead, the user equipment 10 records the permutation D103 of the selected figures by clicking the content and sequence of the selected figures. For example, if the plain code D105 that the user intends to input is 8761 and the 12 figures are represented by A-L arranged from left to right and from top to bottom, then the user respectively clicks the figure 1061 (represented by A) which shows “8” at the top left corner, the figure 1061 (represented by G) which shows “7” at the bottom left corner, the figure 1061 (represented by I) which shows “6” at the bottom right corner, and the figure 1061 (represented by C) which shows “1” at the top right corner of the dynamic keyboard 106, but the user equipment 10 does not record the numeric values “8761”. Instead, the user equipment 10 records the content and sequence of the figures 1061 selected by the user. That is, the user equipment 10 records “AGIC”, which is a permutation D103 of the selected figures. Therefore, even the cracker has implanted Trojans to the user equipment 10 and tries to key log the stored data, the cracker will be unable to obtain the plain code D105 that the user has inputted. In some embodiments, the permutation D103 of the selected figures records the relative positions or coordinates of the selected figures rather than the content of the selected figures. For example, the plain code D105 of FIG. 2 being “8761” can be recorded as “top left, bottom left, bottom right and top right” or as “(1, 3), (3, 1), (3, 3) and (1, 3)”.

Then, the method proceeds to step S05, the permutation D103 of the selected figures is transformed into a hash code D104 by the calculation unit 11 of the user equipment 10, and the hash code D104 is transmitted to a back-end device 20 by a transmission unit 16 of the user equipment 10. The figure factor D102 of the dynamic keyboard 106 generated by the user equipment 10 is different at each time. Even when the user clicks the dynamic keyboard 106 according to the same plain code D105 (for example, “8761” of FIG. 2), character such as text style and background colors of the FIGS. 1061 will be different at each time, and the hash code D104 calculated according to the permutation D103 of the selected figures will be different accordingly. Therefore, during the process of uploading the hash code D104 to the back-end device 20, even if the data is intercepted by a cracker, the cracker still cannot obtain the plain code D105 that the user actually inputted, and no security problem will occur.

Then, the method proceeds to step S06, the hash code D104 transformed by the user equipment 10 in step S05 is received by the transmission unit 22 of the back-end device 20 and transformed into the plain code D105 by the code transforming unit 21 of the back-end device 20. Since the back-end device 20 stores the key rule D101 of the safety component 12 of the user equipment 10 and receives the dynamic data generated by the user equipment 10 in step S01, an identical dynamic keyboard 106 can be duplicated for transforming the hash code D104 into the plain code D105. In an embodiment, given that step S01 is omitted, the back-end device 20 can duplicate the dynamic keyboard 106 according to the key rule D102 of the safety component 12 and further transforms the hash code D104 into the original plain code D105.

Lastly, the method proceeds to step S07, if the back-end device 20 has a correct plain code D105 stored therein, then the back-end device 20 can verify the plain code D105 inputted by the user to check whether the account password and the transferee account are valid or not. Then, the back-end device 20 responds a verification result to inform the user of the result of transaction or login. In an embodiment, step S07 can be omitted, and the plain code D105 is used directly without being verified.

According to the data inputting and uploading system according to an embodiment of the invention indicated in FIG. 3, data can be inputted to a user equipment 10 (also referred as a user terminal or a front-end device), and then transmitted to a back-end device 20. The system has high security during the inputting process and the transmission process, and can be used to process sensitive or private data such as user account, password, transferee account, transfer amount and so on. The user equipment 10 can be a communication device requiring enhanced transaction safety such as a mobile phone, a PC Tablet, point of sale (POS) machine or a computer. The user interface of data input can be an Internet banking App, a web browser or an embedded webpage. The back-end device 20 can be a server of an Internet banking site, an Internet shopping site or a membership service website. Data transmission between the user equipment 10 and the back-end device 20 and within the user equipment 10 can be implemented by way of cabled or wireless network, Bluetooth, infra-red, near field communication (NFC), and audio source, and is not subjected to any specific restrictions in the invention.

As indicated in FIG. 3, the user equipment 10 comprises a calculation unit 11, a safety component 12, a graphic unit 13, a display unit 14, a storage unit 15, and a transmission unit 16. Coupling relationships between the said units are exemplary only, not for restricting the implementation of FIG. 3. The safety component 12 can be a physical component (for example, a chip on a smart card 30) installed inside the user equipment 10 through a slot (for example, an SD, a USB, a serial port, a parallel port and so on) or a jack (for example, a headphone jack) by way of wired connection. The safety component 12 stores a key rule D101, such as a one-time password, a symmetric key, an asymmetric key or a hash function, and can generate a figure factor D102 of a dynamic keyboard 106. To further enhance security, it can be designed that the safety component 12 cannot read the key rule D101 unless an extra PIN is inputted. The calculation unit 11 calculates the figure factor D102 according to the key rule D101. The graphic unit 13 can generate a dynamic keyboard 106 (FIG. 2) according to the figure factor D102, wherein the dynamic keyboard 106 is displayed by the display unit 14. After the dynamic keyboard 106 is clicked by the user, the permutation D103 of the selected figures generated accordingly is recorded by the storage unit 15. The calculation unit 11 can transform the permutation D103 of the selected figures recorded by the storage unit 15 into a hash code D104, which is accordingly uploaded to the back-end device 20 by the transmission unit 16.

In an embodiment, when the user equipment 10 is a portable electronic device as indicated in FIG. 2, the user equipment 10 is connected to the network through a smart card 30 (for example, a SIM card or a USIM card), and the safety component 12 can be an IC chip attached to the smart card 30.

As indicated in FIG. 3, the back-end device 20 comprises a code transforming unit 21, a back-end transmission unit 22 and a verification unit 23. The back-end transmission unit 22 receives the hash code D104 from the user equipment 10 as well as the dynamic data generated in step S01 as indicated in FIG. 1. The code transforming unit 21 transforms the hash code D104 into the plain code D105 that the user intends to input. If the back-end device 20 has a plain code D105 stored therein, the verification unit 23 verifies the validity of the plain code D105. In some embodiments, the back-end device 20 can be dispensed with the verification unit 23.

According to the method and the system for inputting and uploading data disclosed in above embodiments, a dynamic keyboard 106 is generated by a physical safety component 12 of the user equipment 10. The dynamic keyboard 106 is for the user to input a sensitive or private plain code D105. After the dynamic keyboard 106 is clicked by the user, what is stored in the user equipment 10 is a permutation D103 of the selected figures instead of the plain code D105 to assure the security during the inputting process. During the process of uploading data to the back-end device 20, the plain code D105 is represented by an encrypted hash code D104. Therefore, even when the data was intercepted by a cracker, the cracker cannot obtain actual values nor change actual values by way of changing the hash code D104. Therefore, both the process of inputting data and the process of transmitting data have high security.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A data inputting and uploading method, comprising following steps:
generating a figure factor by a user equipment according to a key rule;
generating a dynamic keyboard by the user equipment according to the figure factor, wherein the dynamic keyboard is composed of a plurality of figures;
recording a permutation of the selected figures of the dynamic keyboard by the user equipment;
transforming the permutation of the selected figures into a hash code by the user equipment; and
receiving and transforming the hash code into a plain code by a back-end device.

2. The method according to claim 1, wherein the step of generating the figure factor comprises:
generating the dynamic data by the user equipment according to a random number, a system status data or an input content; and
transforming the dynamic data into the figure factor by the user equipment according to the key rule.

3. The method according to claim 2, wherein the system status data is a system time or an identification code of the user equipment, and the input content is a user account, an order number, a membership number or a transferee account.

4. The method according to claim 1, wherein following the step of transforming the hash code into the plain code by the back-end device, the method further comprises:
verifying the validity of the plain code by the back-end device.

5. The method according to claim 1, wherein the figures of the dynamic keyboard have different texts, fonts, colors and backgrounds, and each figure displays a plain code.

6. The method according to claim 1, wherein the permutation of the selected figures records the click sequence and content of the selected figures.

7. A data inputting and uploading system, comprising:
a user equipment, comprising:
a safety component for storing a key rule; and
a calculation unit for generating a figure factor according to the key rule;
a graphic unit for generating a dynamic keyboard according to the figure factor, wherein the dynamic is composed of a plurality of figures;
a display unit for displaying the dynamic keyboard;
a storage unit for recording a permutation of the selected figures of the dynamic keyboard, wherein the calculation unit transforms the permutation of the selected figures into a hash code; and
a user-end transmission unit for transmitting the hash code; and
a back-end device, comprising:
a back-end transmission unit for receiving the hash code; and
a code transforming unit for transforming the hash code into a plain code.

8. The system according to claim 7, wherein the calculation unit generates a dynamic data according to a random number, a system status data or an input content and transforms the dynamic data into the figure factor according to the key rule.

9. The system according to claim 8, wherein the system status data is a system time or an identification code of the user equipment, and the input content is a user account, an order number, a membership number or a transferee account.

10. The system according to claim 7, wherein the back-end device further comprises:
a verification unit for verifying the validity of the plain code.

11. The system according to claim 7, wherein the figures of the dynamic keyboard have different texts, fonts, colors and backgrounds, and each figure displays a plain code.

12. The system according to claim 7, wherein the permutation of selected the figures records the click sequence and content of the selected figures.

13. The system according to claim 7, wherein the user equipment is a mobile communication device, and the safety component is a physical component attached to the mobile communication device.
